(19) United States
(12) Patent Application Publication
(10) Pub. No.: US 2006/0215604 A1
(43) Pub. Date: Sep. 28, 2006

(54) Scheduling method for enhanced uplink channels

(76) Inventors: Jens Mueckenheim, Nuremberg (DE); Mirko Schacht, Nuremberg (DE)

Correspondence Address: HARNESS, DICKEY & PIERCE, P.L.C., P.O. BOX 8910, RESTON, VA, 20195, US

(21) Appl. No.: 11/087,810

(22) Filed: Mar. 24, 2005

(51) Int. Cl. H04Q 7/00

(52) U.S. Cl. 370/329

(57) ABSTRACT

A method for scheduling uplink data transmission by user equipment (UE) in a wireless communication network is provided. The method may comprise scheduling data transmission by the user equipment in response to physical layer signaling received from the user equipment.

### BACKGROUND OF THE INVENTION

FIG. 1 illustrates a portion of a UMTS wireless communication network. As shown, user equipment UE wirelessly communicates with a Node-B serving the communication needs of a geographic area (often referred to as a cell or collection of cells). A UE may be a mobile phone, wireless equipped PDA, wireless equipped laptop, etc. Node-Bs communicate with a radio network controller (RNC), which may configure the UE and the Node-B for communication over enhanced dedicated channels (EDCHs). For example, the RNC may configure an enhanced transport format combination set ETFCS, which may be used by the UE and the Node-B in the uplink direction. The ETFCS may include a plurality of enhanced transport format combinations ETFCs, which may be used for communication between a UE and a Node-B. An ETFC is a selected combination of currently valid enhanced transport formats ETFs, which may be used for transmitting data over an EDCH. An enhanced transport format ETF specifies a data rate to be used for a subsequent transmission over a data portion of the EDCH.

UMTS Radio Access Networks RANs (e.g., Node-B's, RNCs, etc.) use two scheduling methods for transmission over enhanced dedicated channels (EDCH); Node-B scheduling (e.g., MAC-e signaling transmission scheduling), and non-scheduled transmission.

In a Node-B scheduling approach, scheduling decisions are made at each Node-B and communicated to the UEs. The scheduling decisions may be made at the Medium Access Control (MAC) Layer and communicated to the Physical (PHY) Layer. As illustrated in FIG. 2, the MAC Layer may interface with the PHY. The PHY Layer supports all functions required for transmitting bit streams on a physical medium, and the MAC Layer (e.g., the MAC-entity of the MAC Layer) may provide access to the services/functions provided by the PHY Layer. For example, the PHY Layer and the MAC Layer may exchange information (e.g., status information associated with the PHY Layer), and/or function together to transfer of data over a radio interface.

A Node-B scheduler allocates a specific (e.g., a maximum) ETFC, from the ETFCS, that a UE may use in the uplink direction, for example, based on Quality of Service related information (e.g., logical channel priority for each logical channel) and scheduling information (e.g., UE buffer capacity, a rate request bit setting, etc.) from the UE. The ETFC may be sent in a resource indication (or scheduling grant).

UMTS-RANs include two types of scheduling grants, an enhanced absolute grant and an enhanced relative grant. An absolute grant is sent to the UE on the enhanced absolute grant channel (EAGCH) providing, for example, the ETFC selected from the ETFCS. The UE may then use this ETFC for transmitting data in the uplink direction.

A relative grant (or update) is sent to the UE on the Enhanced Relative Grant Channel (ERGCH) and serves as a complement to the absolute grant. A relative grant may adjust (e.g., increase or decrease) the selected enhanced transport format combination (ETFC) provided in an absolute grant, and may have one of three values, “Up”, “Down”, and “Hold”. A relative grant may be generated by the Node-B, for example, in response to an “Up” rate request bit received from the UE over an enhanced dedicated physical control channel (EDPCCH). A rate request bit (e.g., a happy bit (HP)), which may indicate whether the UE is satisfied with the current parameters (e.g., the maximum ETFC) provided by a previous absolute grant or relative grant.

If the UE has power available to transmit data at a higher ETFC and the total amount of data in the transmit buffer would require a greater number of Transmission Time Intervals (TTIs) than currently allotted (e.g., via the previous scheduling grant), the UE may transmit an “Up” rate request bit. The Node-B may then transmit a relative grant “Up” over the ERGCH to the UE in response to the received “Up” rate request bit. The relative grant “Up” allows the UE to increase the ETFC one-step, that is, to the next higher ETFC value in the ETFCS.

In conventional UMTS-RANs, the above discussed MAC-e signaling required for the Node-B scheduling approach may result in an unacceptable delay in scheduling time sensitive (e.g., delay critical) services such as voice-over-IP or VoIP.

In the above mentioned non-scheduled transmission, a UE may send a limited amount of data at any time without notification from Node-B. However, non-scheduled transmission may only allow statistical control the loading of a cell by the Node-B, for example, because the UEs may be allowed to transmit at any time.

### SUMMARY OF THE INVENTION

Example embodiments of the present invention relate to scheduling and configuration methods in wireless communication networks, for example, UMTS Radio Access Networks.

An example embodiment of the present invention provides a method for scheduling uplink data transmission by a UE in a wireless communication network. The method may comprise scheduling data transmission by the UE in response to physical layer signaling received from the UE.

Another example embodiment of the present invention may comprise sending, from a physical layer of the UE, an indicator indicating that data is present in a transmission buffer at the UE.

Another example embodiment of the present invention may comprise configuring a physical layer of a UE to send an indicator indicating whether a transmission buffer of the UE includes data for transmission.

Another example embodiment of the present invention may comprise configuring a base station to interpret a received indicator as indicating whether a transmission buffer of a UE includes data for transmission.

Example embodiments of the present invention may further comprise receiving an indicator indicating that data is present in the transmission buffer, and the scheduling step may schedule data transmission in response to the received indicator. The indicator may be received over a control portion of an enhanced dedicated channel, and the control portion may be an enhanced dedicated physical control channel.

Example embodiments of the present invention may further comprise sending a scheduling grant to the UE, and the scheduling grant may be a relative grant sent over an enhanced relative grant channel.

In example embodiments of the present invention, the physical layer signaling may be a rate request bit indicating that data is present in a transmission buffer at the UE.

In example embodiments of the present invention, the configuring step may further configure the UE for transmitting data over an enhanced data channel.

In example embodiments of the present invention, the configuring step may change criteria of an existing indicator to indicate whether a transmission buffer of the UE includes data for transmission.

In example embodiments of the present invention, the configuring step may change criteria for setting a rate request bit of an enhanced dedicated control channel such that the rate request bit may be set if the transmission buffer of the UE includes data for transmission.

In example embodiments of the present invention, the configuring step may further configure a transport format indicator to trigger transmission of data at the UE in response to a scheduling grant.

In example embodiments of the present invention, the configuring step may further configure the base station for receiving data over an enhanced data channel.

In example embodiments of the present invention, the configuring step may change criteria for interpreting an existing indicator as indicating whether a transmission buffer of the UE includes data for transmission.

In example embodiments of the present invention, the configuring step may change criteria for interpreting a rate request bit of an enhanced dedicated control channel such that the rate request bit indicates that the transmission buffer of the UE includes data for transmission if the rate request bit is set.

In example embodiments of the present invention, the configuring step may further configure a transport format indicator to trigger transmission of data at the UE in response to a scheduling grant.

### BRIEF DESCRIPTION OF THE DRAWINGS

The present invention will become more fully understood from the detailed description given herein below and the accompanying drawings, wherein like elements are represented by like reference numerals, which are given by way of illustration only and thus are not limiting of the present invention and wherein:

FIG. 1 illustrates a portion of a conventional UMTS-RAN;

FIG. 2 illustrates an example of the Radio Resource Layer (RRC) and the Medium Access Control (MAC) Layer interfaces with the Physical Layer (PHY);

FIG. 3 is a flow chart illustrating a configuration method according to an example embodiment of the present invention.

FIG. 4 illustrates message signaling flow between a UE and a Node-B, according to an example embodiment of the present invention; and

FIG. 5 is a flow chart illustrating a scheduling method according to an example embodiment of the present invention.

### DETAILED DESCRIPTION OF THE EMBODIMENTS

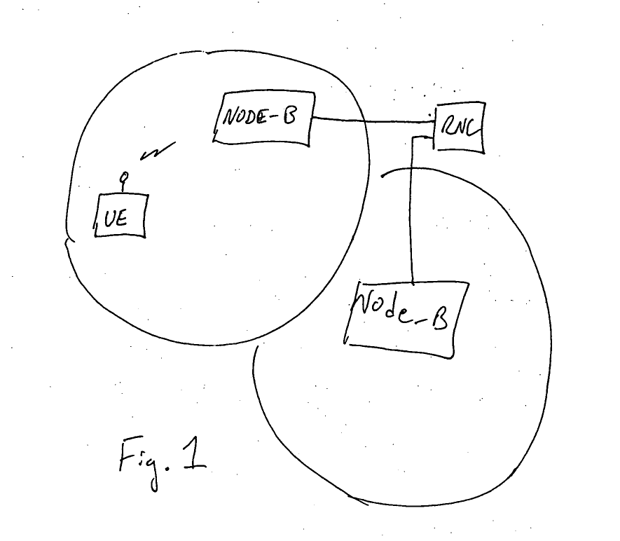

Example embodiments of the present invention will be described with respect to UMTS such as shown in FIG. 1. However, it will be understood that UE may be, for example, a mobile phone, wireless equipped PDA, wireless equipped laptop, or any other suitable mobile device.

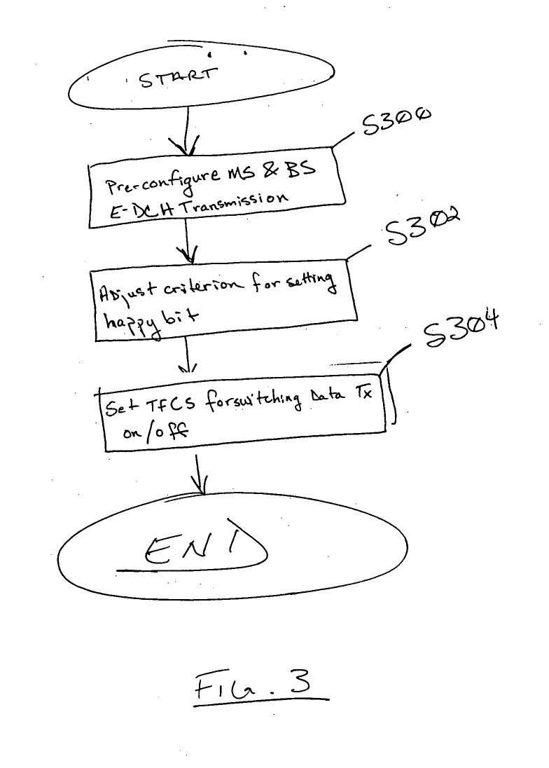

FIG. 3 is a flow chart illustrating a configuration method according to an example embodiment of the present invention. The configuration method, for example, as illustrated in FIG. 3, may be performed by an RNC in a UMTS-RAN such as illustrated in FIG. 1.

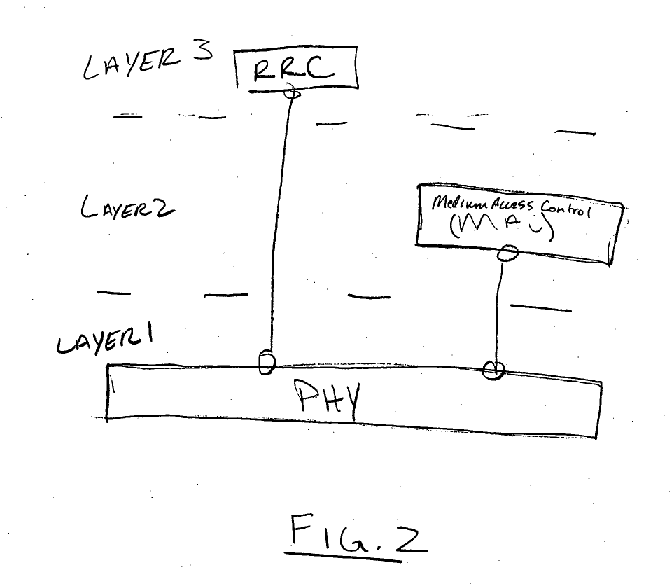

At step S300, the RNC may pre-configure UE and a Node-B, in communication therewith, for EDCH transmission using Radio Resource Control (RRC) messages. RRC messages may be generated by the Radio Resource Control (RRC) Layer (e.g., illustrated in FIG. 2). The RRC Layer interfaces the PHY Layer in both the UE and the network, and the RRC Layer controls the configuration of the PHY Layer. For example, using RRC messages, a dedicated data channel DCH established between the UE and the Node-B in a UMTS-RAN may be configured for EDCH transmission in at least a data portion (Enhanced Dedicated Physical Data Channel (EDPDCH)), a control portion (Enhanced Dedicated Physical Control Channel (EDPCCH)), an absolute grant portion (Enhanced Absolute Grant Channel (EAGCH)), and a relative grant portion (Enhanced Relative Grant Channel (ERGCH)). The EDPDCH may be used for transmitting data, and the EDPCCH may be used for transmitting control information, for example, an enhanced transport format indicator (ETFCI) indicating a selected ETFC and a rate request bit (e.g., a happy bit). The EAGCH may be used for transmitting absolute grants AGs to the UE. The ERGCH may be used for transmitting relative grant RG messages in the uplink direction.

Returning to FIG. 3, at S302, the RNC may adjust the criteria for setting the rate request bit so that the rate request bit indicates whether data is present in a transmission buffer at the UE. For example, the rate request bit may be set “Hold” (e.g., a “1” or a “0”), when the transmission buffer does not contain any data to be transmitted, and the rate request bit may be set “Up” (e.g., a “0” or a “1”, respective to the “Hold” setting) when data is present in a transmission buffer.

At step S304, the RNC may configure the ETFCS to include two TFCs for the EDCH between the UE and the Node-B. For example, the ETFCS may be set such that data transmission is switched on or off in response to a relative grant “Up” or “Down”, respectively, on the ERGCH. An ETFC reference table, with a configurable step width may be used, and within the reference table, a step width between the ETF0 (no transmission) and the smallest ETFC of the reference table (enabled upon reception of a first, single RG “Up”) may be large enough such that a packet (e.g., a VoIP packet) may be sent by the UE.

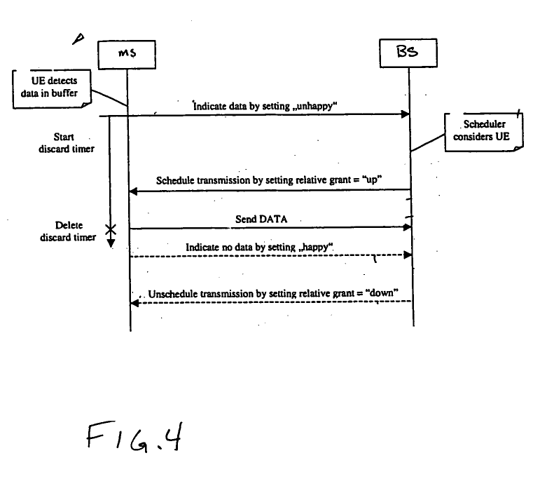

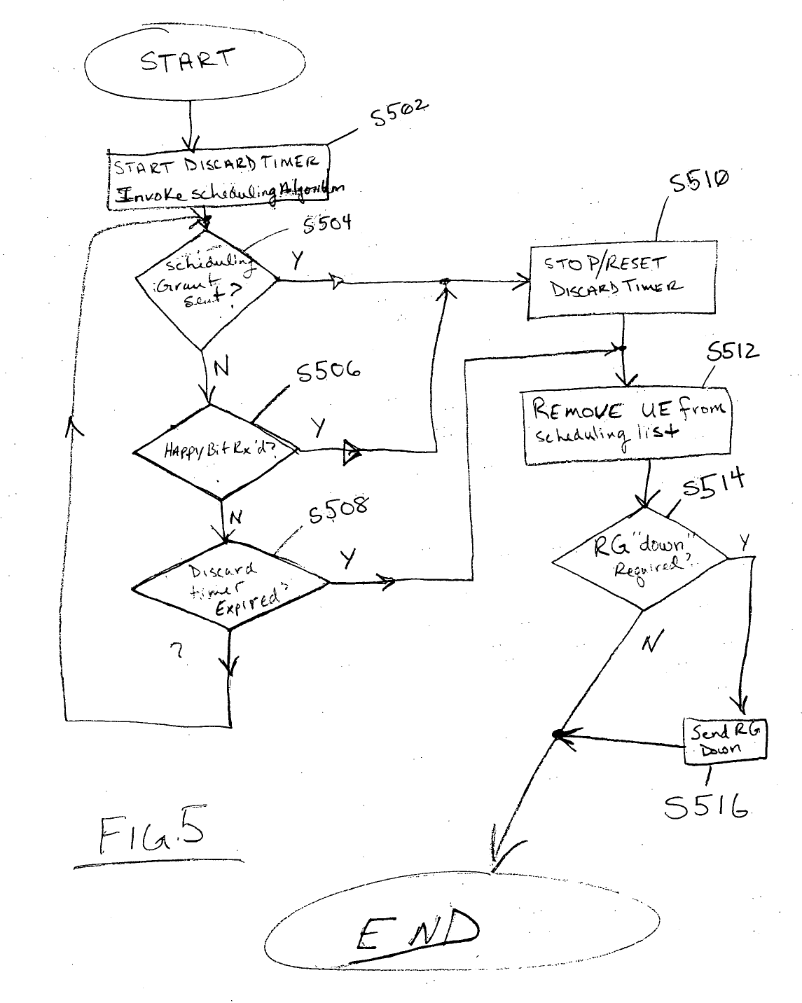

After the configuration method has been performed, a scheduling method, according to an example embodiment of the present invention may be performed. Signaling performed during, and the actual scheduling method performed at the Node-B, according to an example embodiment of the present invention, will be described in more detail with regard to FIGS. 4 and 5, respectively.

FIG. 4 is a message flow diagram illustrating transmission between UE and a Node-B. For ease of illustration, only the communication with the EDCH serving cell is shown. However, it is assumed that the methods as described herein may be performed in the same manner for non-serving cells.

Referring to FIG. 4, when data arrives (e.g., a voice packet) at a UE, the packet may be stored in a transmission buffer at the UE. As the buffer was previously empty, the physical layer within the UE detects the packet based on the presence of data in the transmission buffer.

Upon detection of the received packet, the physical layer within the UE indicates the reception of the packet to the Node-B by setting the rate request bit to “Up”. As discussed above, the “Up” rate request bit may be sent to Node-B on the EDPCCH.

At the same time the rate request bit is set to “Up”, the UE may start an internal discard timer, which may be used to delete packets from the transmission buffer, for example, when they are outdated and no longer useful. Discard timers may be used in order to preserve a Quality of Service (QoS) for time sensitive (e.g., delay critical) traffic, such as, for example, VoIP.

Upon reception of the “Up” rate request bit from the UE, the Node-B may invoke a scheduling algorithm for scheduling the UE for transmission (e.g., using a MAC-e scheduling). A scheduling method using PHY Layer signaling, according to an example embodiment of the present invention, will be described in more detail below with regard to FIG. 5.

After the scheduling algorithm has been invoked, at the appropriate time (e.g., the UE's scheduled transmission time), the Node-B may send a relative grant to “Up” indicating that the UE may transmit. As discussed above, the relative grant may be sent to the UE on the ERGCH.

Upon the reception of the relative grant “Up” the UE may transmit data, for example, by sending a Packet Data Unit (PDU, e.g., a MAC-e PDU) using EDCH transmission. After transmitting the data, the UE may delete the discard timer and indicate an empty transmission buffer by sending a “Hold” rate request bit to the Node-B on the EDPCCH.

In order to disable further uncontrolled transmission from that UE, the Node-B may send a relative grant “Down” to the UE to end further transmission by the UE.

Referring back to FIG. 4, if the internal discard timer (as discussed above) at the UE expires before the UE receives a relative grant “Up” from the Node-B, the UE may delete the data from the transmission buffer. After deleting the data from the transmit buffer, the UE may send a “Hold” rate request bit to the Node-B indicating that the transmission buffer is empty.

In example embodiments of the present invention, a relative grant provided by the Node-B may have a validity duration, which may expire after a time period sufficient to initiate transmission of a data packet at the UE. In this case, a relative grant “Down” may be unnecessary.

FIG. 5 is a flowchart illustrating a scheduling method, according to an example embodiment of the present invention. The scheduling method as shown in FIG. 5 will be described with respect to a MAC-e scheduling algorithm, which uses the physical (PHY) layer signaling as described with respect to FIG. 4.

At S502, the Node-B may receive an indicator from the UE indicating the presence of data in its transmission buffer. As discussed above, the UE may indicate the presence of data in the transmission buffer by setting the rate request bit to “Up”. After detecting the “Up” rate request bit, a scheduler (e.g., a MAC-e scheduler) at the Node-B may start a discard timer for the UE and may invoke a scheduling method for scheduling the UE for transmission by inserting the UE into a scheduling list. For example, any suitable scheduling algorithm such as proportional fair, simple round-robin scheduling, etc. may be used. The MAC-e scheduling algorithm may be performed in a Node-B for all users allocated to EDCHs for a specific cell. Once invoked, the scheduling algorithm may run in parallel with the method as illustrated in FIG. 5.

Returning to FIG. 5, at step S504, the scheduler may determine whether a scheduling grant has been sent to the UE. If a scheduling grant (e.g., a relative grant RG) has been sent to the UE, the scheduler may assume that the transmission buffer will be empty after the EDCH transmission, and hence will no longer need to be scheduled. Subsequently, the scheduler may stop the discard timer, at S510, and remove the UE from the scheduling list, at S512.

At S514, the scheduler may determine whether a relative grant RG “Down” is needed to stop further transmission by the UE, for example, if the RG does not have a validity duration. If the scheduler determines that a relative grant “Down” is necessary, the scheduler may send a relative grant “Down” to the UE, at S516.

Returning to step S514, if the scheduler determines that a relative grant “Down” is unnecessary, the process may terminate and repeat after another “Up” rate request bit is received from the UE.

Returning to step S504, if a scheduling grant has not yet been sent to the UE, the scheduler may determine if a “Hold” rate request bit has been received from the UE, at step S506. If a “Hold” rate request bit has been received, the method may proceed to step S510. The method may then proceed from step S510 as described above.

Returning to step S506, if a “Hold” rate request bit has not been received, the scheduler may determine if the discard timer has expired, at S508. If the discard timer has expired, the method may proceed to step S512. The method may then proceed from step S512 as described above.

Returning to step S508, if the discard timer has not yet expired, the method may return to step S504 and again determine if the UE has been scheduled, at S504. The process may then proceed from step S504 as described above.

Although discussed above with regard to a single UE, it will be understood that this method of scheduling may be performed for more than one UE in the scheduling list simultaneously. Further, it will also be understood that steps S504, S506, and S508, although illustrated as sequential steps, may be parallel processes.

In example embodiments of the present invention, it will be understood that steps S510, S512, and S514, although illustrated as sequential steps, may be parallel processes.

In addition to the PHY signaling described herein, the scheduler may also use additional information, which is provided within MAC-e layer. For example, the UE may provide information about buffer status and available transmit power, which may be sent either within a MAC-e PDU including regular data or as a separate MAC-e control PDU. Further, a Node-B may adjust any ETFC by sending absolute scheduling grants on the EAGCH.

Transmission indication/control using physical (PHY) layer signaling may improve the speed of the procedure, for example, on the order off a few Transmission Time Intervals (TTI). On an EDCH the Transmission Time Intervals (TTIs) may be, for example, two milliseconds.

Example embodiments of the present invention may provide configuration of a UE to report the presence or non-presence of data using an indicator, for example, a rate request bit.

Example embodiments of the present invention may allow the ETFC to switch transmission on or off by setting of the relative grant “Up” and “Down”, respectively.

Example embodiments of the present invention may provide a scheduling method, which may use two state information data or no data, and which may control transmission using the two states on and off.

Example embodiments of the present invention may provide a scheduling method that may use (but not limited to), for example, pure physical (PHY) signaling to control data transmission by users.

Example embodiments of the present invention may offers improved control of resource usage in a UMTS UTRAN network.

In example embodiments of the present invention, physical (PHY) signaling, for example, using rate request bit and relative grant may provide a faster scheduling method. For example, physical (PHY) signaling may be applied at every EDCH TTI, which may be every two milliseconds.

Example embodiments of the present invention may provide physical (PHY) signaling, which may reduce overhead normally associated with conventional scheduling methods.

Although example embodiments of the present invention have been described with regard to a MAC-e scheduling algorithm, it will be understood that the example embodiments of the present invention may be combined with any suitable scheduling algorithms.

The invention being thus described, it will be obvious that the same may be varied in many ways. For example, while the embodiments described above concerned the EDCH in a UMTS wireless communication system, the present invention is not limited in application to this channel or a UMTS system. Such variations are not to be regarded as a departure from the invention, and all such modifications are intended to be included within the scope of the invention.

We claim:

1. A method for scheduling uplink data transmission by a UE in a wireless communication network, the method comprising:
scheduling data transmission by the UE in response to physical layer signaling received from the UE.

2. The method of claim 1, wherein the physical layer signaling is an indicator indicating that data is present in a transmission buffer at the UE.

3. The method of claim 2, wherein the indicator is a rate request bit.

4. The method of claim 2, further comprising:
receiving the indicator indicating that data is present in the transmission buffer; and wherein
the scheduling step schedules data transmission in response to the received indicator.

5. The method of claim 4, wherein the indicator is received over a control portion of an enhanced dedicated channel.

6. The method of claim 5, wherein the control portion is an enhanced dedicated physical control channel.

7. The method of claim 1, further comprising:
sending a scheduling grant to the UE.

8. The method of claim 7, wherein the scheduling grant is a relative grant sent over an enhanced relative grant channel.

9. A method comprising:
sending, from a physical layer of the UE, an indicator indicating that data is present in a transmission buffer at the UE.

10. The method of claim 9, further comprising:
receiving a scheduling grant.

11. The method of claim 10, wherein the scheduling grant is a relative grant received over an enhanced relative grant channel.

12. The method of claim 9, wherein the indicator is sent over a control portion of a dedicated channel.

13. The method of claim 11, wherein the control portion is an enhanced dedicated physical control channel.

14. The method of claim 11, wherein the indicator is rate request bit.

15. A method, comprising:
configuring a physical layer of a UE to send an indicator indicating whether a transmission buffer of the UE includes data for transmission.

16. The method of claim 15, wherein the configuring step further configures the UE for transmitting data over an enhanced data channel.

17. The method of claim 15, wherein the configuring step changes criteria of an existing indicator to indicate whether a transmission buffer of the UE includes data for transmission.

18. The method of claim 15, wherein the configuring step changes criteria for setting a rate request bit of an enhanced dedicated control channel such that the rate request bit is set if the transmission buffer of the UE includes data for transmission.

19. The method of claim 15, wherein the configuring step further configures a transport format indicator to trigger transmission of data at the UE in response to a scheduling grant.

20. A method, comprising:
configuring a base station to interpret a received indicator as indicating whether a transmission buffer of a UE includes data for transmission.

21. The method of claim 20, wherein the configuring step further configures the base station for receiving data over an enhanced data channel.

22. The method of claim 20, wherein the configuring step changes criteria for interpreting an existing indicator as indicating whether a transmission buffer of the UE includes data for transmission.

23. The method of claim 20, wherein the configuring step changes criteria for interpreting a rate request bit of an enhanced dedicated control channel such that the rate request bit indicates that the transmission buffer of the UE includes data for transmission if the rate request bit is set.

24. The method of claim 20, wherein the configuring step further configures a transport format indicator to trigger transmission of data at the UE in response to a scheduling grant.
